(19) United States
(12) Patent Application Publication
(10) Pub. No.: US 2010/0131687 A1
(43) Pub. Date: May 27, 2010

(54) WIRELESS REMOTE USB HUB APPARATUS AND SYSTEM THEREOF

(75) Inventors: YEN-RUEY LI, Taipei (TW); CHING-HSIANG LEE, Taipei (TW)

Correspondence Address: KILE GOEKJIAN REED & MCMANUS, 1200 NEW HAMPSHIRE AVE, NW, SUITE 570, WASHINGTON, DC, 20036, US

(73) Assignee: AZUREWAVE TECHNOLOGIES, INC.

(21) Appl. No.: 12/411,699

(22) Filed: Mar. 26, 2009

(30) Foreign Application Priority Data
Nov. 26, 2008 (TW) 97221140

(51) Int. Cl. G06F 13/42; G06F 1/00

(52) U.S. Cl. 710/106; 713/310

(57) ABSTRACT

A wireless remote USB hub apparatus includes a server end operation processor module as the data processing center, for converting and processing data; a server end wireless Wi-Fi communication module is coupled to the server end operation processor module, for transceiving data of Wi-Fi communication protocol format; and at least one USB port, for connecting electronic devices that supports USB, such as a USB drive or printer. When the electronic device connects to the USB port, the server end operation processor module receives a connection signal data from the USB port, converts the connection signal data format into Wi-Fi communication protocol format, and then transmits the connection signal data via the server end wireless Wi-Fi communication module to a personal computer or other client device. Thereby a user of the client device may remotely utilize the electronic device connected to the wireless remote USB hub apparatus.

### CROSS-REFERENCE TO RELATED APPLICATION

This application claims priority under 35 U.S.C. § 119 to Taiwan Patent Application No. 097221140, filed on Nov. 26, 2008, in the Taiwan Intellectual Property Office, the entire contents of which are hereby incorporated by reference.

### BACKGROUND OF THE INVENTION

1. Field of the Invention

The present invention relates to a universal serial bus (USB) hub apparatus and system thereof; in particular, to a wireless remote USB hub and system thereof that wirelessly connects a server (the USB-Hub) and a client device via Wi-Fi transmission.

2. Description of Related Art

Modern science and technology has been developing rapidly, subsequently many electronic devices have been invented, such as printers, web cams, digital televisions, etc. As the number of electronic devices increases, the number of necessary connection cables increases accordingly. The large number of connection cables may make a user feel inconvenient. In order to reduce the number of connection cables, wireless transmission technology has been developed and is subsequently popular, with a wide range of applications in various fields.

Due to the different required functions, wireless transmission technology includes many platforms and formats, for example the worldwide interoperability for microwave access (WiMX), used for long range wide area transmission as in a metropolitan area network (MAN); wireless fidelity (Wi-Fi), used for intermediate range transmission as in a local area network (LAN); Bluetooth, used for short range transmission as in a small personal area network (PAN) between two electronic devices; and ZigBee used for low speed, low consumption wireless networks.

As more electronic devices are invented, the use of connection cables also increases accordingly. Therefore, the technology of wireless transmission is becoming more and more important. Additionally, because the universal serial bus (USB) interface is commonly used today for electronic devices, wireless hubs utilizing USB have been invented. However, prior art wireless USB hubs are all designed for the ultra-wide band platform, and thus their wireless transmission range is short, the cost of production is high, and their performance is unsatisfactory.

### SUMMARY OF THE INVENTION

The object of the present invention is to provide a wireless remote USB hub apparatus and system thereof, wherein the design of the wireless remote USB hub apparatus may be utilized for a Wi-Fi platform. Due to the fact that the communication format of the Wi-Fi platform allows for further and wider range of signal transmission, and because many personal computers or electronic devices have Wi-Fi built in, there is no additional hardware device required, so that not only is the transmission range increased, but the over all device cost is lower.

In order to achieve the aforementioned objects, according to an embodiment of the present invention, a wireless remote USB hub apparatus is provided, the apparatus includes a server end operation processor module, which acts as the data processing center for the wireless remote USB hub apparatus, for converting and processing data; a server end wireless Wi-Fi communication module is coupled to the server end operation processor module, for transceiving data of Wi-Fi communication protocol format; and at least one USB port coupled to the server end operation processor module, for connecting an electronic device that supports USB, such as a USB drive, a printer, or a web cam, etc. Therein, when the electronic device connects with the USB port, the server end operation processor module receives a connection signal data from the USB port, and converts the signal format of the connection signal data into the Wi-Fi communication protocol format, so that the connection signal data may be transmitted to a personal computer or other devices via the server end wireless Wi-Fi communication module.

According to another embodiment of the present invention, a wireless remote USB hub system is provided, which includes a wireless remote USB hub apparatus and a client device, such as a personal computer. Therein the wireless remote USB hub apparatus includes a server end operation processor module, which acts as the data processing center for the wireless remote USB hub apparatus, for converting and processing data; a server end wireless Wi-Fi communication module is coupled to the server end operation processor module, for transceiving data of Wi-Fi communication protocol format; and at least one USB port coupled to the server end operation processor module, for connecting an electronic device that supports USB, such as a USB drive, a printer, or a web cam, etc. The client device primarily includes a client end operation processor module, for converting and processing data; a client end wireless Wi-Fi communication module is coupled to the client end operation processor module, for transceiving data of Wi-Fi communication protocol format; and a client end storage unit which is coupled to the client end operation processor module, for storing at least the driver program and data of an electronic device. Similarly, when the electronic device is connected to USB port of the wireless remote USB hub apparatus, the server end operation processor module receives a connection signal data from the USB port, and converts the signal format of the connection signal data into Wi-Fi communication protocol format, then wirelessly transmitted to the client device via the server end wireless Wi-Fi communication module. The client device receives the connection signal data via the client end wireless Wi-Fi communication module, which is then transmitted to the client end operation processor module. Thereby the client end operation processor module may read the driver program from the client end storage unit that corresponds to the electronic device that has been connected according to the connection signal data, so as to facilitate the long range remote usage of the electronic device.

By utilizing the wireless remote USB hub apparatus with Wi-Fi platform design, the electronic device may be controlled and used remotely, and because of the remote transmission and common availability of Wi-Fi, the transmission range may be easily extended without purchasing extra devices, so that the object of long range wireless utilization of a plurality of electronic device may be achieved and the implantation cost is lowered.

The aforementioned illustrations and following detailed descriptions are exemplary for the purpose of further explaining the scope of the present invention. Other objectives and advantages related to the present invention will be illustrated in the subsequent descriptions and appended drawings.

### BRIEF DESCRIPTION OF THE DRAWINGS

FIG. 1 shows a wireless remote USB hub apparatus according to an embodiment of the present invention.

FIG. 2 shows a client device of a wireless remote USB hub system according to an embodiment of the present invention.

FIG. 3 shows steps of a wireless remote USB hub system operation flowchart according to an embodiment of the present invention.

FIG. 4 shows the front side view of a wireless remote USB hub apparatus according to an embodiment of the present invention.

FIG. 5 shows the back side view of a wireless remote USB hub apparatus according to an embodiment of the present invention.

FIG. 6 shows an operation schematic diagram of a wireless remote USB hub system according to the present invention.

### DETAILED DESCRIPTION OF THE PREFERRED EMBODIMENTS

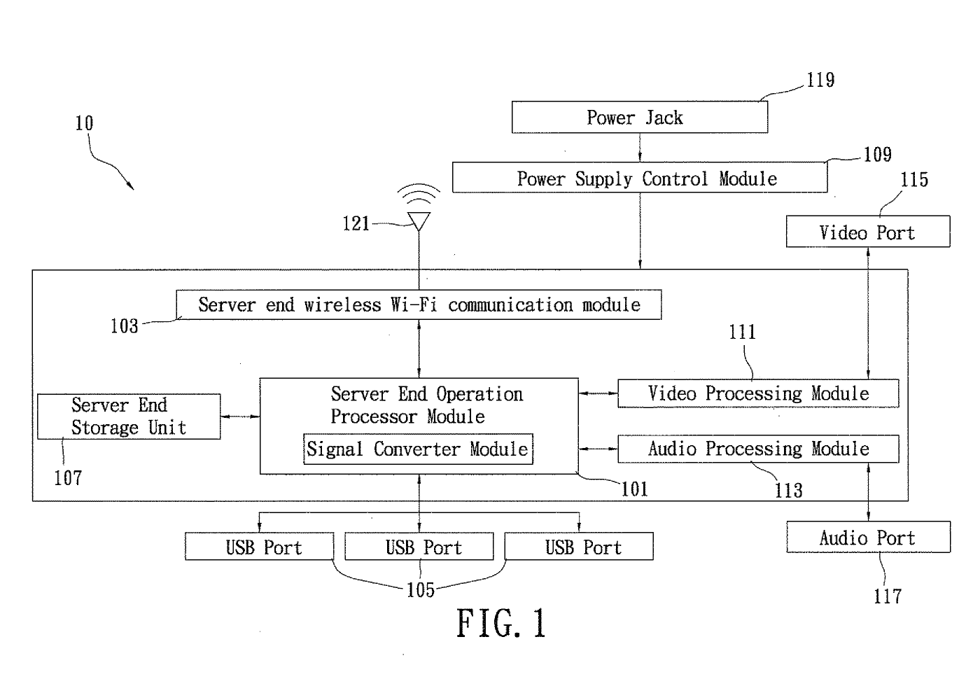

Please refer to FIG. 1, which shows a block diagram of a wireless remote USB hub apparatus according to an embodiment of the present invention, the wireless remote USB hub apparatus 10 includes a server end operation processor module 101, which is the data processing center for the wireless remote USB hub apparatus 10, for converting and processing data. Therein the wireless remote USB hub apparatus 10 further includes a signal converter module, for converting the signal format of the data between the Wi-Fi communication protocol format and the USB protocol format. A server end wireless Wi-Fi communication module 103 is coupled to the server end operation processor module 10, for transceiving data of Wi-Fi communication protocol format. There is also an antenna 121 coupled to the server end wireless Wi-Fi communication module 103. There is at least one USB port 105, coupled to the server end operation processor module 10, for connecting an electronic device that supports USB, such as printers or web cams. A server end storage unit 107 is coupled to the server end operation processor module 10, for storing data. A video processing module 111 is coupled to the server end operation processor module 10, for processing video data; wherein the video processing module 111 is coupled to a video port 115, such as a video graphics array (VGA) port, a digital visual interface (DVI) port, or a high-definition multimedia interface (HDMI) port, etc, for connecting to a display device. An audio processing module 113 is coupled to the server end operation processor module 10, for processing audio data; wherein the audio processing module 113 is coupled to an audio port 117 for connecting to a loudspeaker device. A power supply control module 109 is coupled to the server end operation processor module 10, so as to provide the necessary power for the operation of the wireless remote USB hub apparatus 10; wherein the power supply control module 109 is coupled to a power jack 119 for connecting to an external power source.

When the electronic device is connected to the USB port 105, the server end operation processor module 101 receives a connection signal data from the USB port 105, and converts the signal format of the connection signal data to Wi-Fi communication protocol format, so as to wirelessly transmit the connection signal data to a personal computer or other devices via the server end wireless Wi-Fi communication module 103.

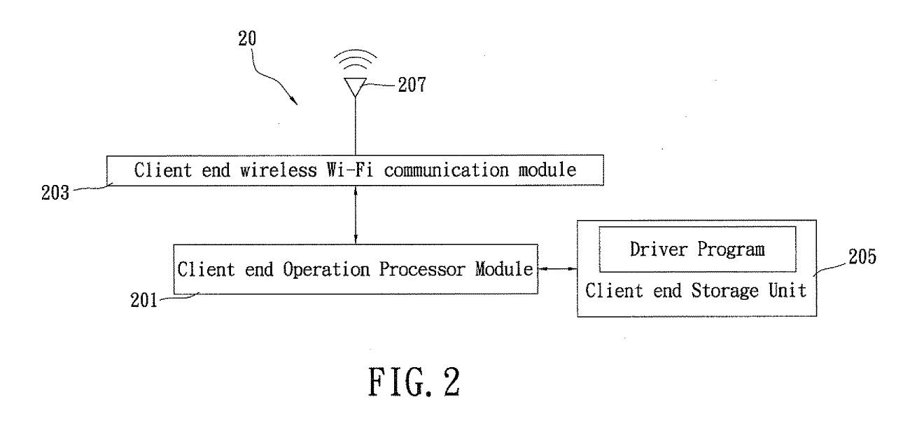

Refer to FIG. 2, which shows a client device according to an embodiment of the present invention, such as a notebook computer 20. Therein the client device includes a client end operation processor module 201 for converting and processing data; a client end wireless Wi-Fi communication module 203, coupled to the client end operation processor module 201, for transceiving data of Wi-Fi communication protocol format; an antenna 207, coupled to the client end wireless Wi-Fi communication module 203; and a client end storage unit 205, coupled to the client end operation processor module 201, for storing at least the driver program and data of the electronic device that connects to the USB port 105.

Please refer to FIGS. 1 and 2, when the electronic device that supports USB is connected to the wireless remote USB hub apparatus 10 via the USB port 105, a connection signal data is transmitted to the server end operation processor module 101, the server end operation processor module 101 then converts the signal format of the connection signal data from the USB protocol format to the Wi-Fi communication protocol format, the connection signal data is then transmitted to the client device (i.e. notebook computer 20) via the server end wireless Wi-Fi communication module 103. The notebook computer 20 receives the connection signal data via the client end wireless Wi-Fi communication module 203, then the connection signal data is transmitted to the client end operation processor module 201, so that the client end operation processor module 201 may, according to the connection signal data, read the driver program from the client end storage unit 205 that corresponds to the electronic device that supports USB.

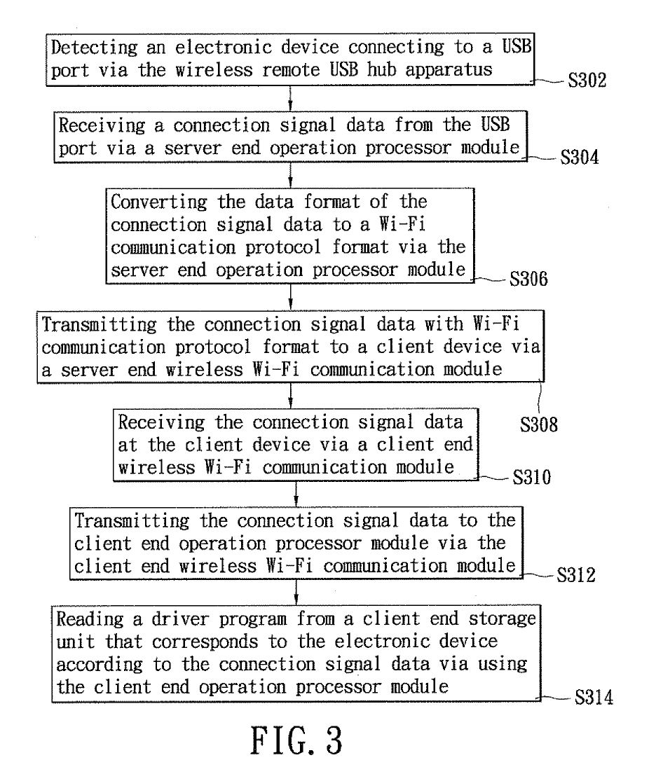

Refer to FIG. 3 in conjunction with FIGS. 1 and 2, which shows steps of a wireless remote USB hub system operation flowchart according to an embodiment of the present invention, the steps includes: detecting an electronic device connecting to a USB port 105 via the wireless remote USB hub apparatus 10 (S302); receiving a connection signal data from the USB port 105 via a server end operation processor module 101 (S304); converting the data format of the connection signal data to a Wi-Fi communication protocol format via the server end operation processor module 101 (S306); transmitting the connection signal data with Wi-Fi communication protocol format to a client device, such as a notebook computer 20, via a server end wireless Wi-Fi communication module 103 (S308); receiving the connection signal data at the client device via a client end wireless Wi-Fi communication module 203 (S310); transmitting the connection signal data to the client end operation processor module 201 via the client end wireless Wi-Fi communication module 203 (S312); and reading a driver program from a client end storage unit 205 that corresponds to the electronic device according to the connection signal data via using the client end operation processor module 201 (S314).

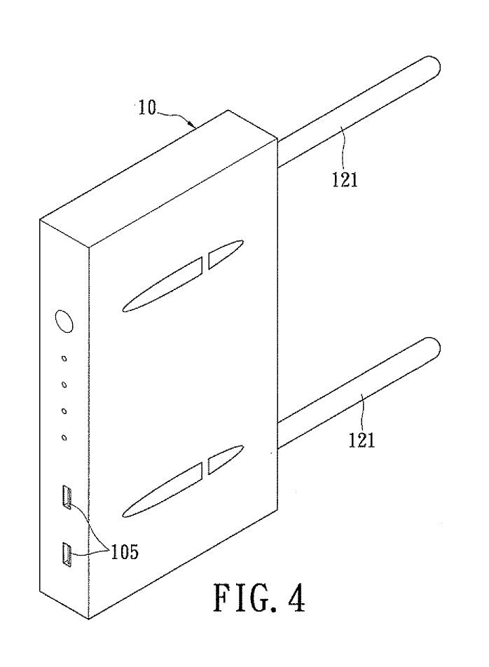

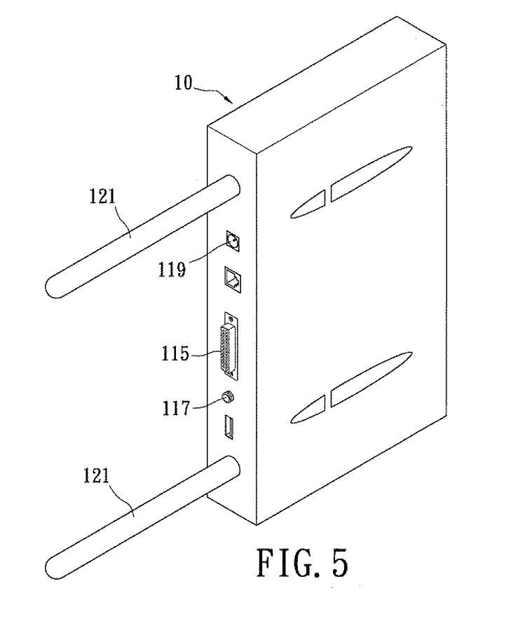

Refer to FIGS. 4 and 5, which show a wireless remote USB hub apparatus according to an embodiment of the present invention, the wireless remote USB hub apparatus 10 includes at least a USB port 105, an antenna 121, a video port 115, an audio port 117, and a power jack 119.

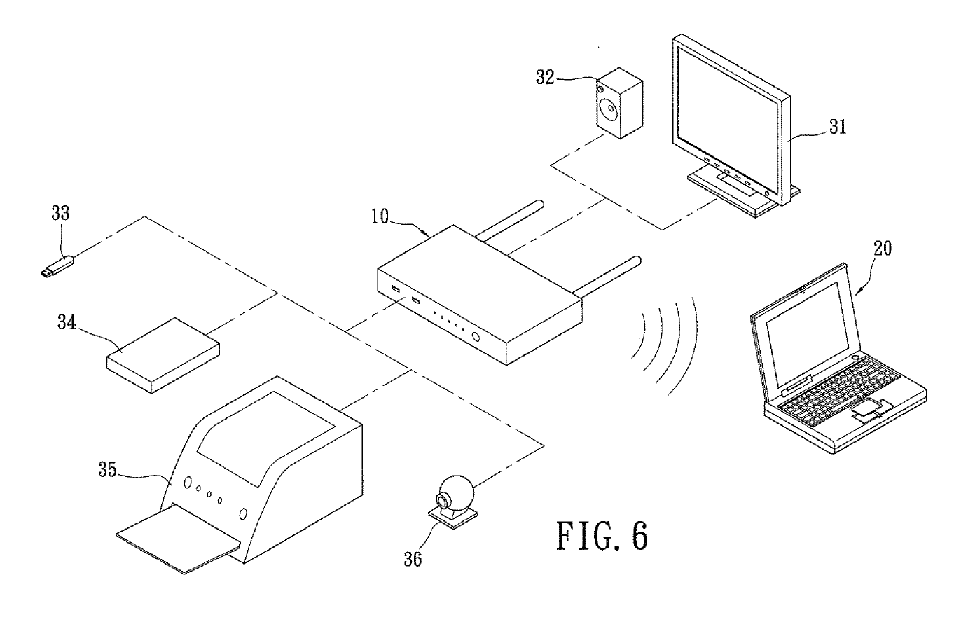

Refer to FIG. 6 in conjunction with FIGS. 1 and 2, which shows an operation schematic diagram of a wireless remote USB hub system according to the present invention. When an electronic device that supports USB, such as a USB drive 33, an external hard drive 34, a printer 35, or a web cam 36, is connected to the wireless remote USB hub apparatus 10 via the USB port 105, then a connection signal data is generated, and the wireless remote USB hub apparatus 10 converts and process the connection signal data to the proper signal format, then transmits the connection signal data to a client device, such as a notebook computer 20. The notebook computer 20 reads the driver program of the electronic device that supports USB according to the connection signal data, so that via wireless signal transmission, may remotely utilize the electronic device. Therein the wireless remote USB hub apparatus 10 may also connect to a display device 31 via the video port 115, such as a VGA port, a DVI port, or a HDMI port; or connect to a loudspeaker device 32 via the audio port 117; thereby the wireless remote USB hub apparatus 10 may remotely control the display device 31 and the loudspeaker device 32.

By utilizing the wireless remote USB hub apparatus 10 with WiFi platform design, the electronic device may be controlled and used remotely, and because of the remote transmission and common availability of Wi-Fi, the transmission range may be easily extended without purchasing extra devices, so that the object of long range wireless utilization of a plurality of electronic device may be achieved and the implantation cost is lowered.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A wireless remote USB hub apparatus, the apparatus comprising:
a server end operation processor module, which is the data processing center of the wireless remote USB hub apparatus, for converting and processing data;
a server end wireless Wi-Fi communication module, coupled to the server end operation processor module, for transceiving data of Wi-Fi communication protocol format; and
at least one USB port, coupled to the server end operation processor module, for connecting an electronic device that supports USB;
wherein the server end operation processor module converts the signal format of the data being transceived between the server end wireless Wi-Fi communication module and the USB port, so that the signal format of the data may be converted between the Wi-Fi communication protocol format and the USB protocol format.

2. The wireless remote USB hub apparatus according to claim 1, wherein the server end operation processor module comprises a signal converter module, for converting the signal format of the data between the Wi-Fi communication protocol format and the USB protocol format.

3. The wireless remote USB hub apparatus according to claim 1, further comprising a video processing module, coupled to the server end operation processor module, for processing video data.

4. The wireless remote USB hub apparatus according to claim 3, wherein the video processing module is further coupled to a video port, for connecting to a display device.

5. The wireless remote USB hub apparatus according to claim 1, further comprising an audio processing module, coupled to the server end operation processor module, for processing audio data.

6. The wireless remote USB hub apparatus according to claim 5, wherein the audio processing module is further coupled to an audio port, for connecting to a loudspeaker device.

7. The wireless remote USB hub apparatus according to claim 1, further comprising a server end storage unit, coupled to the server end operation processor module, for storing data.

8. The wireless remote USB hub apparatus according to claim 1, further comprising a power supply control module, so as to provide the necessary power for the operation of the wireless remote USB hub apparatus.

9. The wireless remote USB hub apparatus according to claim 8, wherein the power supply control module is coupled to a power jack, for connecting to an external power source.

10. A wireless remote USB hub system, the system comprising:
a wireless remote USB hub apparatus, the apparatus comprising;
a server end operation processor module, which is the data processing center of the wireless remote USB hub apparatus, for converting and processing data;
a server end wireless Wi-Fi communication module, coupled to the server end operation processor module, for transceiving data of Wi-Fi communication protocol format; and
at least one USB port, coupled to the server end operation processor module, for connecting an electronic device that supports USB; and
a client device, the device comprising;
a client end operation processor module, for converting and processing data;
a client end wireless Wi-Fi communication module, coupled to the client end operation processor module, for transceiving data of Wi-Fi communication protocol format; and
a client end storage unit, couple to the client end operation processor module, for storing at least the driver program and data of the electronic device;
wherein when the electronic device and the wireless remote USB hub apparatus are connected, a connection signal data is transmitted to the server end operation processor module, and the connection signal data is converted from the USB protocol format to the Wi-Fi communication protocol format then wirelessly transmitted to the client device; the client device receives then transmits the connection signal data to the client end operation processor module, so as to read the driver program from the client end storage unit that corresponds to the electronic device according to the connection signal data.

11. The wireless remote USB hub system according to claim 10, wherein the server end operation processor module comprises a signal converter module, for converting the signal format of the data between the Wi-Fi communication protocol format and the USB protocol format.

12. The wireless remote USB hub system according to claim 10, wherein the wireless remote USB hub apparatus further comprises a video processing module, coupled to the server end operation processor module, for processing video data.

13. The wireless remote USB hub system according to claim 12, wherein the video processing module is further coupled to a video port, for connecting to a display device.

14. The wireless remote USB hub system according to claim 10, wherein the wireless remote USB hub apparatus further comprises an audio processing module, coupled to the server end operation processor module, for processing audio data.

15. The wireless remote USB hub system according to claim 14, wherein the audio processing module is further coupled to an audio port, for connecting to a loudspeaker device.

16. The wireless remote USB hub system according to claim 10, wherein the wireless remote USB hub apparatus further comprises a server end storage unit, coupled to the server end operation processor module, for storing data.

17. The wireless remote USB hub system according to claim 10, wherein the wireless remote USB hub apparatus further comprises a power supply control module, so as to provide the necessary power for the operation of the wireless remote USB hub apparatus.

18. The wireless remote USB hub system according to claim 17, wherein the power supply control module is coupled to a power jack, for connecting to an external power source.
